(19) United States
(12) Patent Application Publication
(10) Pub. No.: US 2013/0063368 A1
(43) Pub. Date: Mar. 14, 2013

(54) TOUCH-SCREEN SURFACE TEMPERATURE CONTROL

(71) Applicants: Avi R. Geiger, Seattle, WA (US); Brandon A. Rubenstein, Lynnwood, WA (US)

(72) Inventors: Avi R. Geiger, Seattle, WA (US); Brandon A. Rubenstein, Lynnwood, WA (US)

(73) Assignee: MICROSOFT CORPORATION, Redmond, WA (US)

(21) Appl. No.: 13/232,343

(22) Filed: Sep. 14, 2011

(51) Int. Cl. G06F 3/041

(52) U.S. Cl. 345/173

(57) ABSTRACT

In embodiments of touch-screen surface temperature control, a computing device includes a touch-screen display with a touch surface for user interaction. The computing device also includes a cooling system that cools a surface temperature on the touch surface of the touch-screen display. A temperature service is implemented to activate the cooling system to decrease the surface temperature on the touch surface of the display based on projected user interaction with the touch surface of the touch-screen display.

### BACKGROUND

Various types of computing and media devices, such as desktop computers, portable computing devices, televisions, and display devices, are increasingly designed with a touch-screen display for user input and touch interaction. Typically, a television or LCD display gets hot from the heat that is generated when the device functions to display content. However, unlike a conventional television that may have a very hot display surface, the surface temperature of a touch-screen display needs to be controlled at a reasonable temperature so that a user can interact with the touch surface without getting burned. This can generally be accomplished with cooling fans that are positioned within the device to cool the touch surface of a display. However, the cooling fans and cooling fan motors may vibrate and/or generate an undesirable background noise, and they also consume battery power when running in a device that is battery-powered. Non-touch displays may run quieter at higher power levels because the temperature of the display surface and heat requirements are much higher than the temperature limit needed for the comfort of user touch interaction on a touch-screen display.

### SUMMARY

This Summary introduces simplified concepts of touch-screen surface temperature control, and the concepts are further described below in the Detailed Description and/or shown in the Figures. This Summary should not be considered to describe essential features of the claimed subject matter, nor used to determine or limit the scope of the claimed subject matter.

Touch-screen surface temperature control is described. In embodiments, a computing device includes a touch-screen display with a touch surface for user interaction. The computing device also includes a cooling system that cools a surface temperature on the touch surface of the touch-screen display. A temperature service is implemented to activate the cooling system to decrease the surface temperature on the touch surface of the display based on projected user interaction with the touch surface of the touch-screen display.

In other embodiments, the temperature service is implemented to receive a service input to determine projected user interaction with the touch-screen display based on any one or combination of: a user input to the computing device; a touch input to the touch surface of the touch-screen display; a display orientation of the touch-screen display; a position of the computing device; software that is executed on the computing device, and the software includes an interactive user interface displayed on the touch-screen display; and detected proximity of a user to the computing device. The temperature service may also be implemented to initiate a display brightness adjustment to decrease heat generated by the touch-screen display and/or initiate an increase of audio level output to compensate for noise generated by the cooling system.

### BRIEF DESCRIPTION OF THE DRAWINGS

Embodiments of touch-screen surface temperature control are described with reference to the following Figures. The same numbers may be used throughout to reference like features and components that are shown in the Figures:

FIG. 1 illustrates examples of touch-screen surface temperature control in accordance with one or more embodiments.

FIG. 2 illustrates example method(s) of touch-screen surface temperature control in accordance with one or more embodiments.

FIG. 3 illustrates various components of an example electronic device in which embodiments of touch-screen surface temperature control can be implemented.

### DETAILED DESCRIPTION

Embodiments of touch-screen surface temperature control are described. As noted above, the surface temperature of a touch-screen display needs to be controlled at a reasonable temperature for user touch interaction. However, the cooling fans and cooling fan motors of a cooling system may vibrate and/or generate an undesirable background noise, and the cooling system consumes battery power when running in a battery-powered device. In embodiments, a temperature service is implemented to monitor the surface temperature of a touch surface on a touch-screen display, and activate a cooling system to decrease the surface temperature based on a projected likelihood of user interaction with the display. The temperature service can activate the cooling system to cool the surface temperature on the display to accommodate user touch interaction. Alternatively, the temperature service can also deactivate the cooling system for passive use of the display, such as when a user is watching a movie. This conserves battery power and also eliminates any undesirable background noise that may be generated by the cooling system.

While features and concepts of touch-screen surface temperature control can be implemented in any number of different devices, systems, and/or configurations, embodiments of touch-screen surface temperature control are described in the context of the following example devices, systems, and methods.

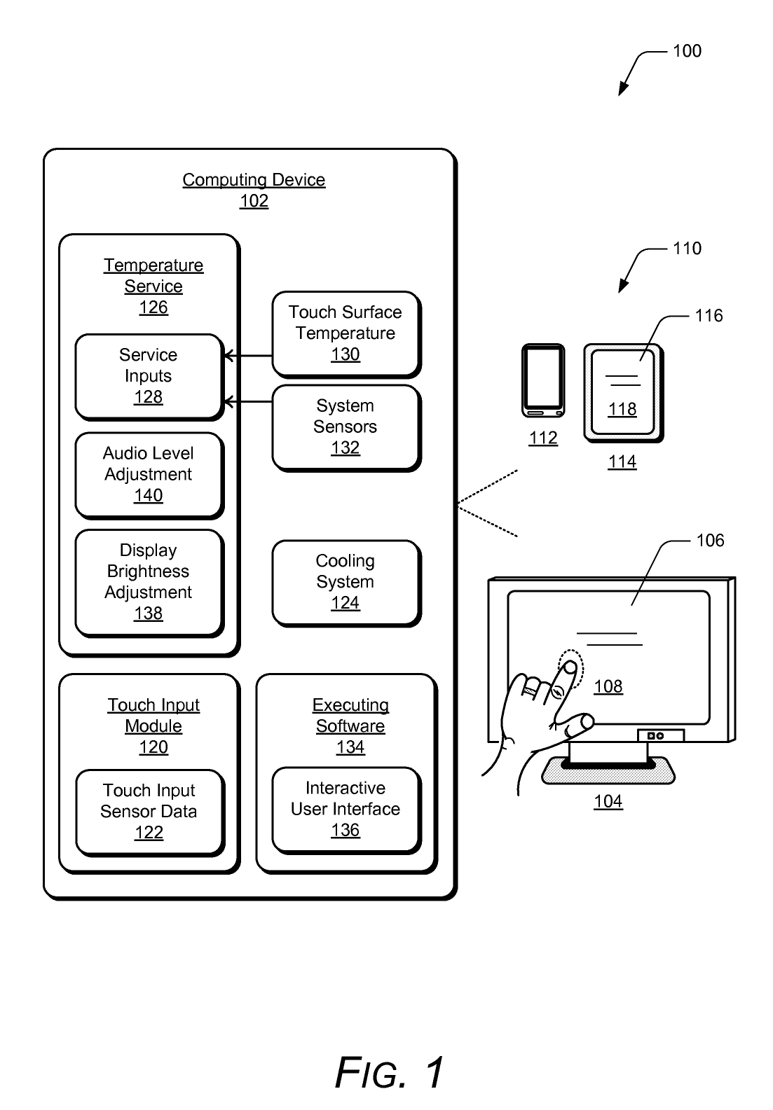

FIG. 1 illustrates an example system 100 in which embodiments of touch-screen surface temperature control can be implemented. The example system 100 includes a computing device 102, which may be any one or combination of a fixed or mobile device, in any form of a consumer, computer, portable, communication, navigation, media playback, entertainment, gaming, tablet, display, and/or electronic device. For example, the computing device 102 can be implemented as a touch-screen display device 104, such as an all-in-one computing device or surface table computing device that includes a touch-screen display 106. In this example, the touch-screen display device 104 includes a touch surface 108 of the touch-screen display for user interaction. The touch-screen display device may be configurable in multiple display orientations, such as in an upright, vertical display orientation or in a flat, horizontal display orientation. A touch-screen display device may also be utilized with a computer, television client device, and/or gaming system that is connected to the display device to display media content.

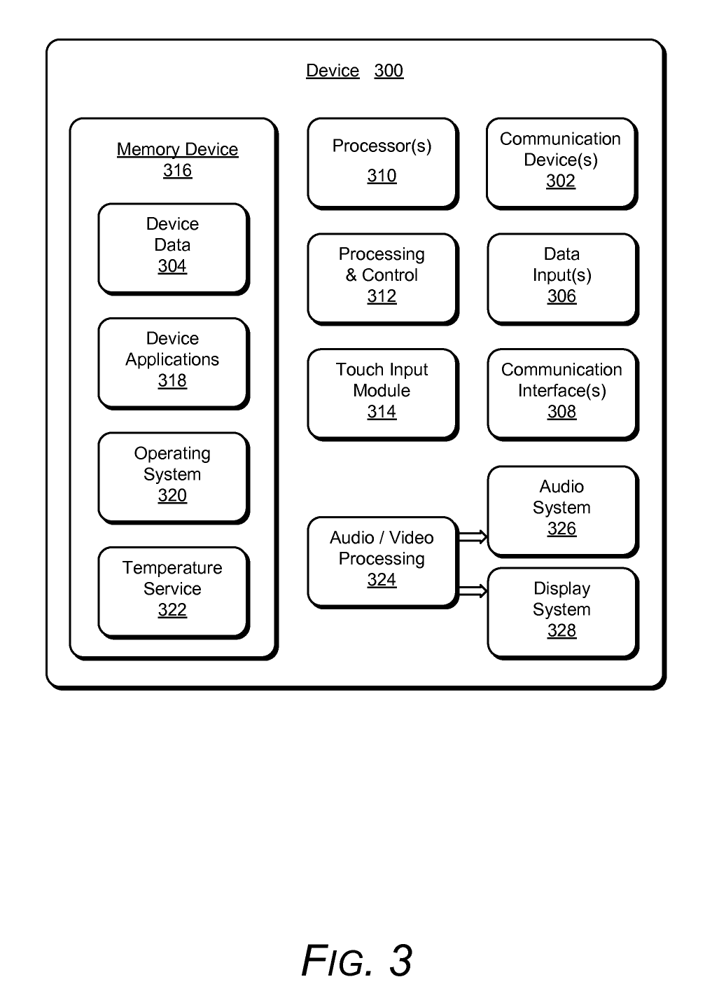

Alternatively, the computing device 102 may be any type of portable computing device 110, such as a mobile phone 112 or tablet computer 114 that includes an integrated, touch-screen display 116 with a touch surface 118 for user interaction with the device. The integrated, touch-screen display of a computing device is implemented to sense touch and gesture inputs on the touch surface, such as user-initiated touch and/or selector inputs in a user interface that is displayed on the touch-screen display. In implementations, the computing device 102 includes a touch input module 120 that recognizes touch input sensor data 122, such as a user touch interaction on the touch surface of the touch-screen display. Additionally, any of the computing devices can be implemented with various components, such as one or more processors and memory devices, as well as with any combination of differing components as further described with reference to the example electronic device shown in FIG. 3.

In this example, the computing device 102 includes a cooling system 124 that is implemented to cool a surface temperature on the touch surface 108 of the touch-screen display 106. The cooling system can include one or more cooling fans and fan motors that are positioned within the computing device to cool the surface temperature on the touch surface of the touch-screen display for user touch interaction. The computing device also includes a temperature service 126 that can be implemented as computer-executable instructions, such as a software application or module that is executed by one or more processors to implement the various embodiments described herein.

The temperature service 126 is implemented to receive various service inputs 128, such as to monitor the touch surface temperature 130 on the touch surface 108 of the touch-screen display 106. The temperature service also receives other service inputs from components, sensors, and/or software on the computing device. For example, the computing device 102 includes system sensors 132, which can be any type of sensors that indicate the proximity of a user to the computing device, such as motion sensors, touch sensors, a camera, and the like. The temperature service is implemented to then project likely user interaction with the touch-screen display based on any one or combination of the various service inputs. Based on a likelihood of user interaction, the temperature service can activate the cooling system 124 to decrease the surface temperature 130 on the touch surface 108 of the touch-screen display.

In addition to receiving the service inputs 128 from the various system sensors 132, the temperature service 126 can project likely user interaction with the touch surface 108 of the touch-screen display 106 based on software 134 that is executing on the computing device. For example, video playback software may be running to display a movie on the touch-screen display, in which case, user interaction with the touch surface of the display may be projected as unlikely while the user passively watches the movie. Alternatively, the software may include an interactive user interface 136 displayed on the touch-screen display, which indicates a likelihood that a user is or will initiate touch interaction on the touch surface of the touch-screen display. The temperature service may also receive a service input 128 from the touch input module 120 that indicates a touch input to the touch surface of the touch-screen display.

The temperature service 126 may also receive the service inputs 128 based on a position of the computing device 102 and/or based on a display orientation of the touch-screen display 106. For example, the touch-screen display device 104 may be positioned in an upright, vertical display orientation and/or wall-mounted, which may be a position indicative of a user passively viewing media content on the display without user interaction, such as when watching a movie. Accordingly, the cooling system 124 may be deactivated allowing the touch surface temperature 130 to increase, while the cooling fans and/or cooling fan motors of the cooling system will not be generating any undesirable background noise in conflict with the movie audio. Alternatively, the tablet computer 114 may be positioned in a flat, horizontal display orientation, which may be a position indicative of likely user interaction with the touch surface 118 of the touch-screen display 116. For example, the tablet computer may be used on a table or desk for email, typing with an on-screen keyboard, flipping through pictures, and the like. Accordingly, the cooling system 124 can be activated by the temperature service 126 to cool the touch surface 118 of the touch-screen display 116.

Alternatively or in addition to activating the cooling system 124, the temperature service 126 can also be implemented to initiate a display brightness adjustment 138 to decrease the heat that is generated by a touch-screen display. This may preclude activation of the cooling system 124, or may be implemented along with activation of the cooling system. For a device under battery power, such as the tablet computer 114, a decrease in the display brightness will conserve battery power, whereas activating the cooling system will likely use more batter power. In an event that the cooling system is activated, the temperature service is also implemented to optionally initiate an increase of an audio level output with an audio level adjustment 140 to compensate for the noise that may be generated by the cooling fans and/or the cooling fan motors of the cooling system.

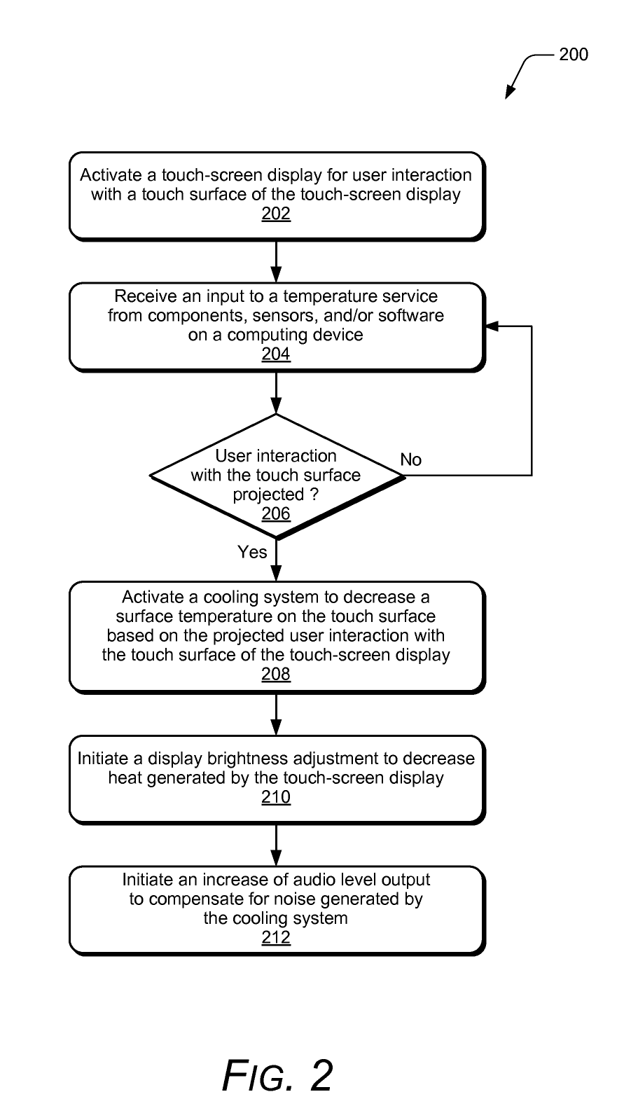

Example method 200 is described with reference to FIG. 2 in accordance with one or more embodiments of touch-screen surface temperature control. Generally, any of the services, functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable storage media devices, both local and/or remote to a computer processor. The methods may also be practiced in a distributed computing environment by multiple computer devices. Further, the features described herein are platform-independent and can be implemented on a variety of computing platforms having a variety of processors.

FIG. 2 illustrates example method(s) 200 of touch-screen surface temperature control. The order in which the method blocks are described are not intended to be construed as a limitation, and any number of the described method blocks can be combined in any order to implement a method, or an alternate method.

At block 202, a touch-screen display is activated for user interaction with a touch surface of the touch-screen display. For example, the computing device 102 (FIG. 1) is representative of the touch-screen display device 104 and also of a portable computing device, such as the tablet computer 114. The touch-screen display device 104 activates the touch-screen display 106 for user interaction with the touch surface 108 of the touch-screen display. Similarly, the tablet computer 114 activates the touch-screen display 116 for user interaction with the touch surface 118 of the touch-screen display. The integrated, touch-screen displays of the computing devices are implemented to sense touch and gesture inputs on the respective touch surfaces, such as user-initiated touch and/or selector inputs in a user interface that is displayed on a touch-screen display.

At block 204, an input to a temperature service is received from components, sensors, and/or software on a computing device. For example, the temperature service 126 at the computing device 102 receives service inputs 128 that can indicate current and/or likely user interaction with the touch surface 108 of the touch-screen display 106. The service inputs can be received as any one or combination of: a user input to the computing device; a touch input to the touch surface of the touch-screen display; a display orientation of the touch-screen display; a position of the computing device; software 134 that is executed on the computing device, and the software includes an interactive user interface 136 displayed on the touch-screen display; and detected proximity of a user to the computing device based on the system sensors 132.

At block 206, a determination is made as to whether user interaction with the touch surface of the touch-screen display is likely based on the one or more inputs to the temperature service received at block 204. For example, the temperature service 126 at the computing device 102 projects likely user interaction with the touch-screen display 106 based on any one or combination of the various service inputs 128. If user interaction with the touch surface of the touch-screen display is not projected (i.e., “no” from block 206), then the method continues at block 204 to monitor for the various service inputs to the temperature service.

If user interaction with the touch surface of the touch-screen display is projected (i.e., “yes” from block 206), then at block 208, a cooling system is activated to decrease a surface temperature on the touch surface based on the projected user interaction with the touch surface of the touch-screen display. For example, the temperature service 126 at the computing device 102 activates the cooling system 124 to decrease the surface temperature 130 on the touch surface 108 of the touch-screen display 106 based on the projected likelihood of user interaction with the display.

Optionally, at block 210, a display brightness adjustment is initiated to decrease heat generated by the touch-screen display. For example, the temperature service 126 at the computing device 102 initiates the display brightness adjustment 138 to decrease the heat generated by a touch-screen display. This may preclude activation of the cooling system 124, or may be implemented along with activation of the cooling system. For a device under battery power, such as the tablet computer 114, a decrease in the display brightness will likely conserve battery power.

Optionally, at block 212, an increase of audio level output is initiated to compensate for noise generated by the cooling system. For example, the temperature service 126 at the computing device 102 initiates an increase of an audio level output with an audio level adjustment 140 to compensate for the noise that may be generated by the cooling fans and/or the cooling fan motors of the cooling system.

FIG. 3 illustrates various components of an example device 300 that can be implemented as any of the devices, or services implemented by the devices, described with reference to the previous FIGS. 1-2. In embodiments, the device may be implemented as any one or combination of a fixed or mobile device, in any form of a consumer, computer, portable, user, communication, phone, navigation, television, appliance, gaming, media playback, and/or electronic device. The device may also be associated with a user (i.e., a person) and/or an entity that operates the device such that a device describes logical devices that include users, software, firmware, hardware, and/or a combination of devices.

The device 300 includes communication devices 302 that enable wired and/or wireless communication of device data 304, such as received data, data that is being received, data scheduled for broadcast, data packets of the data, etc. The device data or other device content can include configuration settings of the device, media content stored on the device, and/or information associated with a user of the device. Media content stored on the device can include any type of audio, video, and/or image data. The device includes one or more data inputs 306 via which any type of data, media content, and/or inputs can be received, such as user-selectable inputs and any other type of audio, video, and/or image data received from any content and/or data source.

The device 300 also includes communication interfaces 308, such as any one or more of a serial, parallel, network, or wireless interface. The communication interfaces provide a connection and/or communication links between the device and a communication network by which other electronic, computing, and communication devices communicate data with the device.

The device 300 includes one or more processors 310 (e.g., any of microprocessors, controllers, and the like) which process various computer-executable instructions. Alternatively or in addition, the device can be implemented with any one or combination of software, hardware, firmware, or fixed logic circuitry that is implemented in connection with processing and control circuits which are generally identified at 312. In embodiments, the device 300 can also include a touch input module 314 that is implemented to recognize touch input sensor data. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 300 also includes one or more memory devices 316 (e.g., computer-readable storage media) that enable data storage, such as random access memory (RAM), non-volatile memory (e.g., read-only memory (ROM), flash memory, etc.), and a disk storage device. A disk storage device may be implemented as any type of magnetic or optical storage device, such as a hard disk drive, a recordable and/or rewriteable disc, and the like. The device may also include a mass storage media device.

Computer readable media can be any available medium or media that is accessed by a computing device. By way of example, and not limitation, computer readable media may comprise storage media and communication media. Storage media include volatile and non-volatile, removable and non-removable media implemented in any method or technology for storage of information, such as computer-readable instructions, data structures, program modules, or other data. Storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computer.

Communication media typically embody computer-readable instructions, data structures, program modules, or other data in a modulated data signal, such as carrier wave or other transport mechanism. Communication media also include any information delivery media. A modulated data signal has one or more of its characteristics set or changed in such a manner as to encode information in the signal. By way of example, and not limitation, communication media include wired media such as a wired network or direct-wired connection, and wireless media such as acoustic, RF, infrared, and other wireless media.

A memory device 316 provides data storage mechanisms to store the device data 304, other types of information and/or data, and various device applications 318. For example, an operating system 320 can be maintained as a software application with the memory device and executed on the processors. The device applications may also include a device manager, such as any form of a control application, software application, signal processing and control module, code that is native to a particular device, a hardware abstraction layer for a particular device, and so on. In this example, the device applications 318 include a temperature service 322 that implements embodiments of touch-screen surface temperature control as described herein.

The device 300 also includes an audio and/or video processing system 324 that generates audio data for an audio system 326 and/or generates display data for a display system 328, such as an integrated touch-screen display. The audio system and/or the display system may include any devices that process, display, and/or otherwise render audio, video, display, and/or image data. Display data and audio signals can be communicated to an audio device and/or to a display device via an RF (radio frequency) link, S-video link, composite video link, component video link, DVI (digital video interface), analog audio connection, or other similar communication link. In implementations, the audio system and/or the display system are integrated components of the example device. Alternatively, the audio system and/or the display system are external components to the device.

Although embodiments of touch-screen surface temperature control have been described in language specific to features and/or methods, the subject of the appended claims is not necessarily limited to the specific features or methods described. Rather, the specific features and methods are disclosed as example implementations of touch-screen surface temperature control.

1. A computing device, comprising:
a touch-screen display that includes a touch surface configured for user interaction;
a cooling system configured to cool a surface temperature on the touch surface of the touch-screen display; and
a temperature service configured to activate the cooling system to decrease the surface temperature on the touch surface based on projected user interaction with the touch surface on the touch-screen display.

2. A computing device as recited in claim 1, wherein the temperature service is configured to receive a service input of the projected user interaction based on a user input to the computing device.

3. A computing device as recited in claim 1, wherein the temperature service is configured to receive a service input of the projected user interaction based on a touch input to the touch surface of the touch-screen display.

4. A computing device as recited in claim 1, wherein the temperature service is configured to receive a service input of the projected user interaction based on a display orientation of the touch-screen display.

5. A computing device as recited in claim 1, wherein the temperature service is configured to receive a service input of the projected user interaction based on a position of the computing device.

6. A computing device as recited in claim 1, wherein the temperature service is configured to receive a service input of the projected user interaction based on software executed on the computing device, the software including an interactive user interface displayed on the touch-screen display.

7. A computing device as recited in claim 1, wherein the temperature service is configured to receive a service input of the projected user interaction based on detected proximity of a user to the computing device.

8. A computing device as recited in claim 1, wherein the temperature service is further configured to initiate a display brightness adjustment to decrease heat generated by the touch-screen display.

9. A computing device as recited in claim 1, wherein the temperature service is further configured to initiate an increase of audio level output to compensate for noise generated by the cooling system.

10. A computer-implemented method, comprising:
activating a touch-screen display for user interaction with a touch surface of a touch-screen display;
projecting the user interaction with the touch surface of the touch-screen display; and
activating a cooling system to decrease a surface temperature on the touch surface based on the projected user interaction with the touch surface of the touch-screen display.

11. A computer-implemented method as recited in claim 10, further comprising receiving a service input of the projected user interaction based on a touch input to the touch surface of the touch-screen display.

12. A computer-implemented method as recited in claim 10, further comprising receiving a service input of the projected user interaction based on a display orientation of the touch-screen display.

13. A computer-implemented method as recited in claim 10, further comprising receiving a service input of the projected user interaction based on an interactive user interface displayed on the touch-screen display.

14. A computer-implemented method as recited in claim 10, further comprising receiving a service input of the projected user interaction based on detected proximity of a user to the touch-screen display.

15. A computer-implemented method as recited in claim 10, further comprising at least one of:
initiating a display brightness adjustment to decrease heat generated by the touch-screen display; or
initiating an increase of audio level output to compensate for noise generated by the cooling system.

16. A touch-screen display device, comprising:
a touch surface configured for user interaction;
a cooling system configured to cool a surface temperature on the touch surface; and
a temperature service executable by a processor and configured to activate the cooling system to decrease the surface temperature on the touch surface based on projected user interaction with the touch surface.

17. A touch-screen display device as recited in claim 16, wherein the temperature service is configured to receive a service input of the projected user interaction based on a user input to the touch-screen display device.

18. A touch-screen display device as recited in claim 16, wherein the temperature service is configured to receive a service input of the projected user interaction based on a display orientation of the touch-screen display device.

19. A touch-screen display device as recited in claim 16, wherein the temperature service is configured to receive a service input of the projected user interaction based on an interactive user interface displayed on the touch-screen display device.

20. A touch-screen display device as recited in claim 16, wherein the temperature service is configured to receive a service input of the projected user interaction based on detected proximity of a user to the touch-screen display device.
